(19) United States
(12) Patent Application Publication
(10) Pub. No.: US 2025/0136113 A1
(43) Pub. Date: May 1, 2025

(54) SYSTEM AND METHOD FOR REMOVING VEHICLE FROM A STUCK CONDITION USING ONE-CLICK ROCK CYCLE

(71) Applicant: FCA US LLC, Auburn Hills, MI (US)

(72) Inventor: Ravi Shanker Ajitsingh Vashishth, Auburn Hills, MI (US)

(21) Appl. No.: 18/496,973

(22) Filed: Oct. 30, 2023

(51) Int. Cl. B60W 30/18

(52) U.S. Cl. CPC B60W 30/18045; B60W 2510/105; B60W 2555/20

(57) ABSTRACT

A vehicle system and method that implements a cycle to vehicle wheels for freeing a vehicle from a stuck condition is provided. The vehicle system includes a drive unit and controller. The drive unit provides a drive toque through a transmission to at least one wheel of the vehicle wheels for propelling the vehicle. The controller has a rock cycle module that determines a torque, a gear shift strategy and a frequency output based on vehicle inputs including wheel speeds of the vehicle wheels. The controller determines whether the rock cycle has been initiated and determines a surface type the vehicle is encountering. A first torque is selected at a torque module. A first gear shift strategy is selected at a gear module. A first frequency is selected at a frequency module. The selected torque, gear shift strategy and frequency are implemented at the drive unit, transmission and vehicle wheels.

### FIELD

The present disclosure relates generally to a system and method for removing a vehicle from a stuck condition automatically using a rock cycle maneuver.

### BACKGROUND

On some occasions vehicles can encounter road surface conditions or a terrain that are difficult for the vehicle to traverse. In certain situations most or all of the vehicle drive wheels are no longer able to propel the vehicle forward or in reverse causing the vehicle to become stuck. Example conditions that can lead to a vehicle becoming stuck can include roads having one or combinations of mud, snow, sand, and ice. In such circumstances where a vehicle becomes stuck, a vehicle driver can attempt to free the vehicle by actively providing throttle input in forward and/or reverse directions. Depending on the severity of the situation, and the skill of the driver, such strategy can be unsuccessful such that the vehicle can remain stuck. Moreover, aggressive driver inputs, such as to the throttle, gear shifter and/or steering system may cause potential damage to vehicle components including the powertrain. Thus, while relying solely on driver skill to free a vehicle from a stuck condition using throttle, gear shifter and steering inputs can be satisfactory, there remains a need for improvement in the relevant art.

### SUMMARY

In one example aspect, a vehicle system that implements a cycle to vehicle wheels for freeing a vehicle from a stuck condition is provided. The vehicle system includes a drive unit and a controller. The drive unit provides a drive toque through a transmission to at least one wheel of the vehicle wheels for propelling the vehicle. The controller has a rock cycle module that determines a torque, a gear shift strategy and an adaptive frequency output based on vehicle inputs including wheel speeds of the vehicle wheels. The controller determines whether the rock cycle has been initiated and determines a surface type the vehicle is encountering. A first toque is selected at a torque module having various torques of the engine associated with various surface types. A first gear is selected at a gear module having various gears of the transmission associated with various gear types. A first frequency is selected at a frequency module having various frequencies including time of operation in the selected torque and gear. The selected torque, gear and frequency are implemented at the engine, the transmission and the vehicle wheels.

In another aspect, the vehicle system includes a driver interface having a rock cycle input that initiates the rock cycle. The driver interface further comprises a brake pedal, an accelerator pedal and a steering wheel. The controller is further configured to determine whether the driver has stopped the rock cycle.

In some implementations, the controller is further configured to determine whether the driver has stopped the rock cycle based on a driver input to at least one of the brake pedal, the accelerator pedal and the steering wheel.

In some implementations, the controller is further configured to confirm, based on a driver input, whether the vehicle is free from the stuck condition.

In some configurations, the controller is configured to, based on a confirmation that the vehicle is not free, wait a cooling time, and subsequent to the cooling time, select at the rock cycle module at least one of the second torque, a second gear shift strategy and a second frequency. The controller implements the at least one second torque, second gear shift strategy and second frequency at the drive unit, transmission and vehicle wheels. The at least one of the second torque, second gear shift strategy and second frequency has an increased intensity compared to the corresponding first toque, first gear shift strategy and first frequency. The vehicle inputs further comprise at least one of an ambient temperature measured from a temperature sensor, an engine speed from an engine speed sensor and a transmission speed from an out put transmission shaft speed sensor.

According to additional examples, a method for implementing a cycle to vehicle wheels for freeing a vehicle from a stuck condition is disclosed. A controller receives vehicle inputs including wheel speeds of the vehicle wheels. The controller determines whether a rock cycle has been initiated. The controller determines a surface type the vehicle is encountering. A rock cycle module implemented by the controller selects a first torque, a first gear shift strategy and a first frequency based on the vehicle inputs and the determined surface type. The first torque is selected from a torque module that stores various torques of the drive unit associated with various surface types. The first gear is selected from a gear module that stores various gear shift strategies of the transmission associated with the various surface types. The first frequency is selected from a frequency module that stores various frequencies including a time of operation in the selected torque and gear shift strategies. The first torque, gear shift strategy and frequency is implemented at the drive unit, transmission and vehicle wheels.

In additional implementations, the method includes determining whether a driver has stopped the rock cycle. The controller further determines whether the driver has stopped the rock cycle based on a driver input to at least one of a brake pedal, an accelerator pedal and a steering wheel. The controller confirms, based on a driver input, whether the vehicle is free from the stuck condition. Based on a confirmation that the vehicle is not free, the controller waits a cooling time and subsequent to the cooling time, selects, at the rock cycle module, at least one of a second torque, a second gear shift strategy and a second frequency. At least one of the second torque, the second gear shift strategy and the second frequency is implemented at the drive unit, transmission and vehicle wheels.

In examples, at least one of the second torque, second gear shift strategy and second frequency has an increased intensity compared to the corresponding first torque, first gear shift strategy and first frequency. The vehicle inputs further comprise at least one of an ambient, drive unit and transmission temperature measured from a temperature sensor, an engine speed from an engine speed sensor, and a transmission speed from a transmission speed sensor.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic block diagram of an exemplary vehicle system according to the principles of the present disclosure;

FIG. 2 is an example functional block diagram of an exemplary controller of the vehicle system of FIG. 1 according to the principles of the present disclosure;

FIG. 3 is an example functional block diagram of a rock cycle module implemented by the exemplary controller of FIG. 2 according to the principles of the present disclosure; and

FIG. 4 illustrates an exemplary flow diagram for implementing rock cycle techniques utilizing aspects of a vehicle system in accordance with the principles of the present disclosure.

### DESCRIPTION

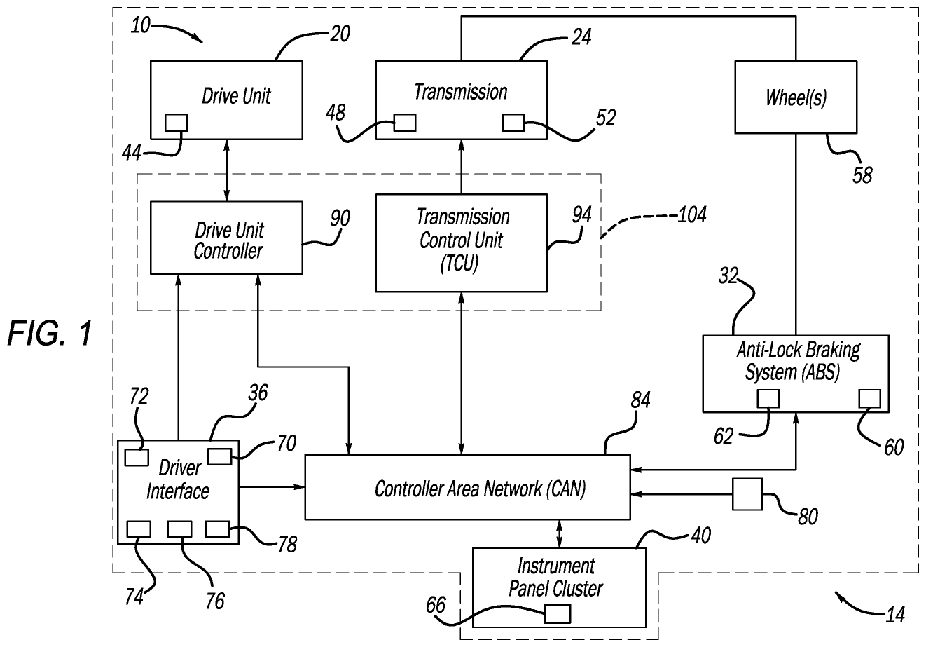

With initial reference to FIG. 1, an exemplary vehicle system is schematically shown and generally identified at reference numeral 10. In accordance with various aspects of the present disclosure, interactive techniques, referred to herein as a “rock cycle” for freeing a vehicle in a stuck condition are implemented utilizing the vehicle system 10. As will be discussed in greater detail below, in one example implementation the interactive rock cycle techniques are initiated upon a vehicle driver selecting a rock cycle event in response to the vehicle becoming stuck. The term “stuck” is used to denote a condition whereby the vehicle is unable to significantly traverse along a particular road condition despite torque inputs to some or all of the vehicle wheels. The term “rock” is used to denote the vehicle powertrain “rocking” the vehicle back-and-forth using torque inputs to the drive wheels.

Once the rock cycle has been initiated, a vehicle controller determines a surface type the vehicle is encountering. The surface type can include, but is not limited to, snow, ice, sand, rain, rocks, etc. The vehicle controller selects a torque, a gear shift strategy and a frequency based on the determined surface type. The rock cycle is then initiated where the controller provides first torque, gear shift strategy and frequency inputs to the vehicle powertrain and ultimately to vehicle drive wheels in an attempt to free the vehicle. Once the rock cycle is initiated, the driver does not provide any supplemental input. In this regard, the vehicle powertrain receives signals by the vehicle controller indicative of various inputs to the drive wheels. The rock cycle ends based on a driver input. If the driver does not confirm that the vehicle is free (unstuck), the rock cycle is repeated but with second torque, gear shift strategy and frequency inputs. Some or all of the second inputs can provide increased intensity. The process repeats, in examples using increased intensity inputs until the vehicle is unstuck or the driver requests an end to the rock cycle.

With continuing reference to FIG. 1, the exemplary vehicle system 10 is associated with an exemplary vehicle 14 and includes a drive unit 20, a transmission 24, an anti-lock brake system (ABS) 32, a driver interface 36 and an instrument panel or cluster 40. The drive unit can be an engine and/or electric motor. The drive unit 20 includes a speed sensor 44. The transmission 24 includes various transmission speed sensors, such as input and output transmission shaft speed sensors 48 and various clutch engagement sensors 52, such as pressure sensors, to provide a signal to an associated control system indicative of engagement of an associated clutch. The transmission 24 and ABS 32 are coupled or selectively coupled, directly or indirectly, to one or more wheels 58 of vehicle 14, as is known in the art. Some or all of the wheels 58 can be drive wheels that receive torque input. The drive unit 20 can be a conventional internal combustion engine (ICE), an electric motor, or combinations thereof.

In the exemplary implementation illustrated, the ABS 32 is controlled to activate foundation brakes 60. The ABS 32 includes one or more wheel speed sensors 62. The instrument panel cluster 40 includes various indicators, such as a rock cycle activate light or indicator 66. The driver interface 36 includes a steering wheel 70 and a brake pedal 72. The driver interface 36 includes a driver input device, e.g., an accelerator pedal 74, for providing a driver input, e.g., a torque request, for drive unit 20. The driver interface 36 further includes a rock cycle input such as a button 76 for initiating a rock cycle sequence. The driver interface 36 or vehicle interior also includes a transmission shift request device, such as a shift lever or rotary shifter 78, for the driver to request a desired transmission 24 gear. The vehicle system 10 also includes sensors 80. The sensors 80 can include longitudinal sensor or other equivalent sensor for providing data indicative of whether or not the vehicle 14 is on a grade and the incline or angle of the grade. The sensors 80 can additionally or alternatively include a temperature sensor that measures ambient temperature.

One or more controllers are utilized to control the various vehicle components or system discussed above. In one exemplary implementation, various individual controllers utilized are to control the various components/systems discussed herein and are in communication with each other and/or the various components/systems via a local interface 84. In this exemplary implementation, the local interface 84 is one or more buses or other wired or wireless connections, as is known in the art. In the example illustrated in FIG. 1, the local interface 84 is a controller area network (CAN). The CAN 84 may include additional elements or features, which have been omitted for simplicity, such as controllers, buffers (cache) drivers, repeaters and receivers, among many others, to enable communications. Further, the CAN 84 may include address, control and/or data connections to enable appropriate communications among the components/systems described herein.

In the example illustrated in FIG. 1, the vehicle system 10 includes a drive unit controller 90 for controlling the drive unit 20, and a transmission control unit (TCU) 94 for controlling the transmission 24. Both of the control units 90 and 94 as well as the ABS 32, driver interface 36, instrument cluster 40 and sensor 80 are in communication with CAN 84 and thus each other. It will be appreciated that while individual control units are discussed herein and shown in various Figures, the individual control units may also be optionally implemented in the form of one control unit, such as a powertrain or vehicle control unit, represented by broken line 104 in FIG. 1. Thus, it will be appreciated that while the discussion will continue with reference to the individual controllers discussed above, the discussion is equally applicable to the components of vehicle system 10 being controlled by one controller.

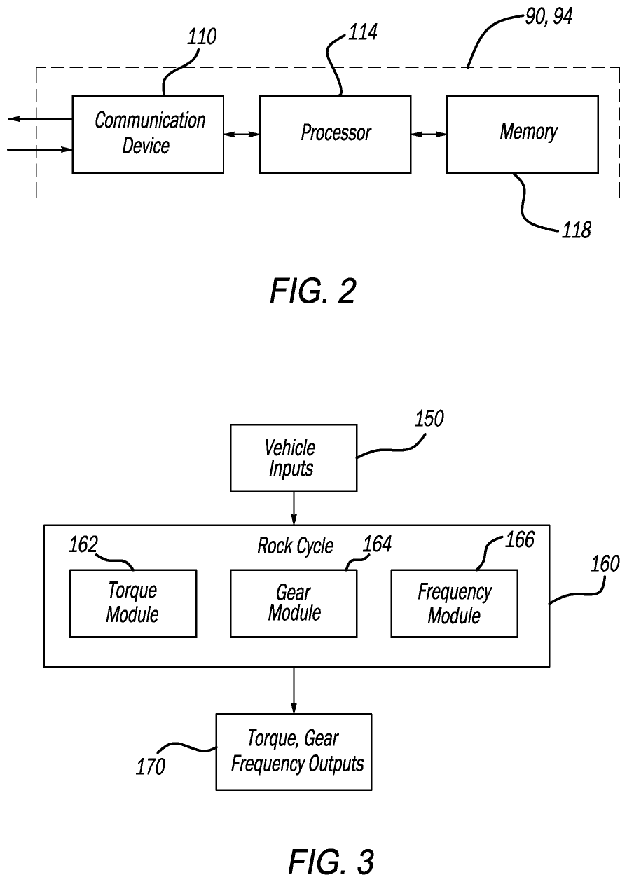

Referring now to FIG. 2 and with reference back to FIG. 1, an example functional block diagram of both of the controllers 90 and 94 is illustrated. Both of the controllers 90 and 94 includes a communication device 110, a processor 114, and a memory 118. The communication device 110 includes suitable components, e.g., a transceiver, configured to communicate with other components of the vehicle system 10 via the controller area network 84. The memory 118 is any suitable storage medium (flash, hard disk, etc.) configured to store information at the respective controller 90 and 94. The processor 114 controls operation of the respective controller 90 and 94 and thus controls operation of the associated systems or components.

Examples of functions performed by the processor 114 include loading/executing an operating system of the respective controller 90 and 94 controlling transmission by and processing information received via the communication device 110, and controlling read/write operations at the memory 118. It will be appreciated that the term “processor” as used herein refers to both a single processor and two or more processors operating in a parallel or distributed architecture.

Turning now to FIG. 3, an example functional block diagram of a rock cycle module 160 implemented by the controller 90, 94 of FIG. 2 is shown. The rock cycle module 160 generally receives vehicle inputs 150 based on initiation of the rock cycle resulting from a driver selecting the rock cycle input or button 76. The rock cycle module 160 comprises a torque module 162, a gear module 164 and a frequency module 166. The torque module 162 stores various torque operational settings associated with various road surface types. A torque setting can include an engine revolutions per minute (RPM) commanded to the engine 20. The torque settings can include various torque values with varying levels of intensity.

The gear module 164 stores various gear operational settings associated with various road surface types. Gear settings can include operation in any of first, second, third gear. A gear setting can additionally or alternatively be associated with a forward and reverse gear and a 4-Low or 4-High drive setting.

The frequency module 166 stores various frequency operational settings associated with various road surface types. Frequency settings can include a time of operation in a selected gear shift strategy at a selected torque. It is appreciated that different torque, gear shift strategy and/or frequency settings can be provided based on a surface type determined. In this regard, the controller 90, 94 may reference a unique torque model, a unique gear model and/or a unique frequency model associated with each surface condition (snow, ice, sand, rain, rocks, etc.). Each of the torque, gear shift strategy and frequency settings can be determined by preset values and/or lookup tables stored at the memory 118 of the controller 90, 94.

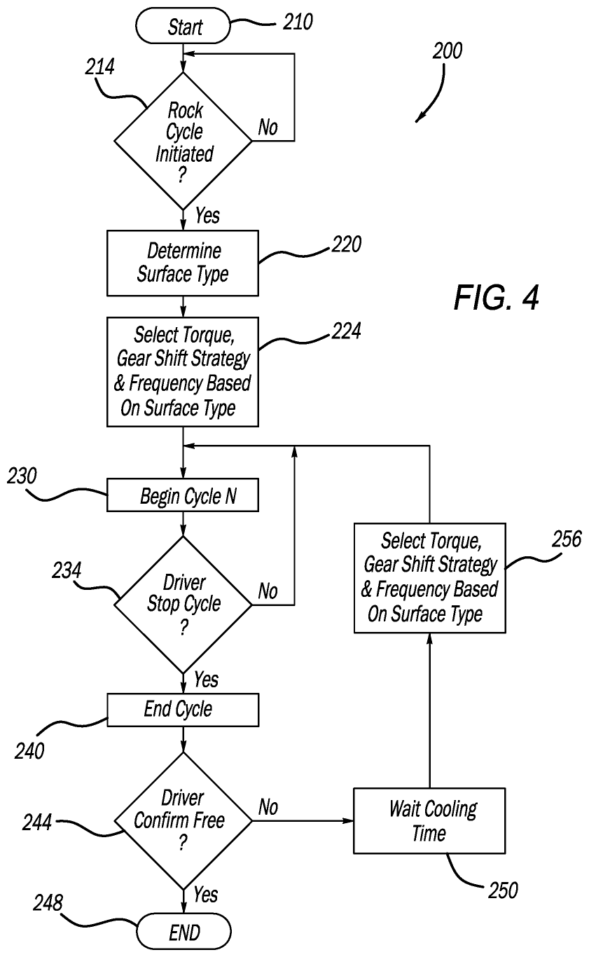

Accordingly, systems and methods or techniques are provided for implementing the rock cycle using the vehicle system 10. One example implementation of such rock cycle technique is discussed below in connection with the exemplary flowchart 200 shown in FIG. 4.

With particular reference to FIG. 4, the exemplary methodology for operating a rock cycle in the vehicle system 10 will be described. The method starts at 210. At 214 control determines whether the rock cycle has been initiated. Again, the rock cycle can be initiated such as by selection of the rock cycle button 76 on the drive interface 36 (see FIG. 1). If the rock cycle has not been initiated, control loops to 214. If rock cycle has been initiated at 214, control determines a surface type the vehicle 14 is encountering. In examples, the controller 90, 94 can determine a surface type based on various vehicle inputs 150. The vehicle inputs can include, but are not limited to, wheel speeds from wheel speed sensors 62, at least one of an ambient temperature, drive unit temperature, transmission temperature measured from a temperature sensor 80, an engine speed from the engine speed sensor 44, a transmission speed from the transmission speed sensors 48 and clutch actuations from the various clutch engagement sensors 52.

At 224 control selects a torque, a gear shift strategy and a frequency based on the determined surface type. Again, the preferred torque, gear shift strategy and frequency to be used by the vehicle powertrain including the engine 20 are output from the torque module 162, the gear module 164 and the frequency module 160 of the rock cycle module 164.

At 230 control begins a first rock cycle. When the rock cycle begins the selected torque, gear shift strategy and frequency are requested and implemented by the vehicle system 10. At 234 control determines whether the driver has stopped the rock cycle. In examples, the driver can stop the rock cycle based on a driver input to one or more of the a steering wheel 70, the brake pedal 72 and the accelerator pedal 74. In some examples, control can also stop the rock cycle based on reaching a time threshold. If the driver has not stopped the rock cycle at 234, control loops to 234. If the driver has stopped the rock cycle at 234, the rock cycle ends at 240. At 244 control determines whether the driver has confirmed the vehicle is free (unstuck).

In examples, the driver can be prompted to answer whether the vehicle is free at the instrument panel cluster 40. If the driver confirms that the vehicle is free at 244, control ends at 248. If the driver indicates that the vehicle is not free at 244, control waits a predetermined time at 250 to cool various components of the vehicle system 10. At 256 control begins another rock cycle at 256 but with increased intensity. As explained above, control can increase intensity of one or more of the torque, gear shift strategy and frequency outputs 170. Control loops to 234.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A vehicle system that implements a cycle to vehicle wheels for freeing a vehicle from a stuck condition, the vehicle system comprising:
a drive unit that provides drive torque through a transmission to at least one wheel of the vehicle wheels for propelling the vehicle;
a controller having a rock cycle module that determines a torque, a gear shift strategy and a frequency output based on vehicle inputs including wheels speeds of the vehicle wheels, wherein the controller:
determines whether the rock cycle has been initiated;
determines a surface type the vehicle is encountering;
selects a first torque, at a torque module of the rock cycle module, the torque module having various torques of the drive unit associated with various surface types;
selects a first gear shift strategy, at a gear module of the rock cycle module, the gear module having various gear shift strategies of the transmission associated with the various surface types;
selects a first frequency, at a frequency module of the rock cycle module, the frequency module having various frequencies including a time of operation in the selected torque and gear; and
implements the selected torque, gear shift strategy and frequency at the drive unit, transmission and vehicle wheels.

2. The vehicle system of claim 1, further comprising:
a driver interface having a rock cycle input that initiates the rock cycle.

3. The vehicle system of claim 2, wherein the driver interface further comprises a brake pedal, an accelerator pedal and a steering wheel.

4. The vehicle system of claim 1 wherein the controller is further configured to:
determine whether a driver has stopped the rock cycle.

5. The vehicle system of claim 4 wherein the controller determines the driver has stopped the rock cycle based on a driver input to at least one of the brake pedal, an accelerator pedal and a steering wheel.

6. The vehicle system of claim 5 wherein the controller is further configured to:
confirm, based on a driver input, whether the vehicle is free from the stuck condition.

7. The vehicle system of claim 6 wherein the controller is configured to, based on a confirmation that the vehicle is not free:
wait a cooling time; and
subsequent to the cooling time, select, at the rock cycle module, at least one of a second torque, a second gear shift strategy and a second frequency;
implement the at least one second torque, second gear shift strategy and second frequency at the drive unit, transmission and vehicle wheels.

8. The vehicle system of claim 7 wherein at least one of the second torque, second gear shift strategy and second frequency has an increased intensity compared to the corresponding first torque, first gear shift strategy and first frequency.

9. The vehicle system of claim 1 wherein the vehicle inputs further comprise at least one of:
an ambient temperature, drive unit temperature and transmission temperature measured from a temperature sensor;
a drive unit speed from a drive unit speed sensor; and
a transmission speed from an output transmission shaft speed sensor.

10. A method for implementing a cycle to vehicle wheels for freeing a vehicle from a stuck condition, the method comprising:
receiving, at a controller, vehicle inputs including wheel speeds of the vehicle wheels, wherein the controller:
determines whether a rock cycle has been initiated;
determines a surface type the vehicle is encountering;
selects, at a rock cycle module implemented by the controller, based on the vehicle inputs and the determined surface type:
a first torque from a torque module that stores various torques of the drive unit associated with various surface types;
a first gear shift strategy from a gear module that stores various gears shift strategy of the transmission associated with the various surface types; and
a first frequency, from a frequency module that stores various frequencies including a time of operation in the selected torque and gear; and
implements the first torque, gear shift strategy and frequency at the drive unit, transmission and vehicle wheels.

11. The method of claim 10, further comprising:
determining whether a driver has stopped the rock cycle.

12. The method of claim 11, further comprising:
determining whether the driver has stopped the rock cycle based on a driver input to at least one of a brake pedal, an accelerator pedal and a steering wheel.

13. The method of claim 11, further comprising:
confirming, based on a driver input, whether the vehicle is free from the stuck condition.

14. The method of claim 13, further comprising:
based on a confirmation that the vehicle is not free:
waiting a cooling time; and
subsequent to the cooling time, selecting, at the rock cycle module, at least one of a second torque, a second gear shift strategy and a second frequency;
implementing the at least one second torque, second gear shift strategy and second frequency at the drive unit, transmission and vehicle wheels.

15. The method of claim 14 wherein at least one of the second torque, second gear shift strategy and second frequency has an increased intensity compared to the corresponding first torque, first gear shift strategy and first frequency.

16. The method of claim 10 wherein the vehicle inputs further comprise at least one of:
an ambient temperature, drive unit temperature and transmission temperature measured from a temperature sensor;
a drive unit speed from a drive unit speed sensor; and
a transmission speed from a transmission speed sensor.
